(19) United States
(12) Patent Application Publication
(10) Pub. No.: US 2012/0177792 A1
(43) Pub. Date: Jul. 12, 2012

(54) METHOD OF MAKING FRIES FROM CREPES

(76) Inventor: Matthew Lee Chatham, Bellingham, MA (US)

(21) Appl. No.: 13/344,972

(22) Filed: Jan. 6, 2012

Related U.S. Application Data
(60) Provisional application No. 61/430,778, filed on Jan. 7, 2011.

(51) Int. Cl. A21D 13/00; A23L 1/01; A21D 6/00

(52) U.S. Cl. 426/289; 426/497; 426/439; 426/549

(57) ABSTRACT

A method of preparing crepe fries as a portable snack food and the resulting food product are disclosed. The method includes preparing a crepe from a batter, cutting the crepe into strips and crisping the strips. The method provides crepe fries that are compartmentalized for portability, convenient, and that can have varied flavoring.

### CROSS REFERENCE TO RELATED APPLICATIONS

This application claims priority under 35 U.S.C. 119(e) to U.S. Provisional Patent Application No. 61/430,778, filed on Jan. 7, 2011.

### BACKGROUND

1. Field of the Invention

The present invention generally relates to food products and methods of preparation thereof. More specifically, the invention relates to crepe fries and methods of preparing the same.

2. Description of Background

A crepe is generally defined as a very thin pancake. Crepes are traditionally served whole, and typically include a filling. For example, traditional methods of preparing a crepe may include rolling the crepe and providing the rolled crepe with a filling. Traditional methods of preparing crepes may also vary the filling to provide crepes having different flavors. However, such traditional methods of preparing crepes produce a food that is messy, and not a portable snacking food. For example, a traditional crepe can be relatively large and contain a filling, which may be in a liquid form. Furthermore, the traditional crepe is soft and can easily soak a liquid filling.

### SUMMARY OF INVENTION

Aspects and embodiments are directed to methods of preparing crepe fries as a portable and versatile snack food. Aspects and embodiments are also directed to providing crepe fries as compartmentalized crepes that may be flavored by batter infusion or coating. The term crepe as disclosed herein is not limiting and may also refer to a pancake or a similar batter-based product.

An aspect of the present disclosure is directed to a method of preparing crepe fries, the method comprising preparing a crepe from a batter, cutting the crepe into strips and crisping the strips to make crepe fries. The method may include coating the crepe fries with a flavoring, such as powdered sugar. The method may include preparing the batter. Preparing the batter may include adding a flavoring to the batter. In contrast with traditional methods of preparing crepes with variable filling, the present method includes adding flavoring to the crepe by infusing the batter and/or coating the crepe fries with a flavoring. Preparing the crepe may include rolling the batter into a crepe. In one example, the crepe may be round, with a diameter of approximately 16 inches. In other embodiments, the crepe may have any shape and size.

In some embodiments, cutting the crepe may include using a pizza rocker to cut the crepe. In one example, the crepe may be cut into strips having a length of approximately 3 to 4 inches and a width of approximately 0.5 to 1 inches. Cutting the crepe may include dividing the crepe into two halves by cutting along a line of symmetry of the crepe, the two halves being substantially identical, flipping one half such that the two halves have the same orientation, and stacking the two halves having the same orientation to make a stacked crepe. Cutting may further include dividing the stacked crepe into two halves by cutting along a line of symmetry of the stacked crepe, the two halves being substantially identical, flipping one half such that the two halves have the same orientation, and stacking the two halves having the same orientation. Cutting may include cutting the stacked crepe along substantially parallel lines to form strips having a substantially uniform width of approximately 0.5 inches. Furthermore, cutting may include cutting the stacked crepe along a direction substantially perpendicular to the parallel lines.

In some embodiments, crisping the strips to make crepe fries further includes deep frying the strips at a temperature of approximately 350 degrees Fahrenheit. The strips may be deep fried for approximately 45 seconds or until the crepe fries are crispy. In other embodiments, crisping the strips may include baking the strips. In yet other embodiments, crisping the strips may include frying the strips. Crisping the strips may include placing the hot crepe fries on an absorbent material. Furthermore, the method may include packaging the crepe fries. Packaging may immediately follow crisping the strips, thereby preparing a warm serving of crepe fries.

Another aspect of the present disclosure is directed to crepe fries having been prepared by the methods disclosed herein.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the disclosure. In the figures, each identical or nearly identical component that is illustrated in various figures is represented by a like numeral. For purposes of clarity, not every component may be labeled in every figure.

In the figures:

FIG. 1 is a flow chart of one example of a method of preparing crepe fries according to aspects of the present invention.

FIG. 2 illustrates one example of a method of preparing crepe fries according to aspects of the present invention.

### DETAILED DESCRIPTION

Aspects and embodiments of this disclosure are directed to providing compartmentalized crepes, referred to herein as crepe fries, and to providing methods of preparing the same. Embodiments of a method disclosed herein provide crepes that are both portable and versatile. Such crepes can be served as a fast food option, while still maintaining the versatility to provide crepes having different flavor options. Making crepes into “fries” increases their appeal in a shopping or quick-treat environment, as well as providing for baseline variability to create flavor options through batter infusion, as opposed to dependency on filling variation.

Crepe fries as provided according to this disclosure are novel snack foods. For example, the ingredient composition of crepe fries is unique versus all other handheld snack foods such as chips, strips and fry balls made from other food origins. The notion of preparing, compartmentalizing and serving a crepe in any manner is also novel because traditional crepes are served whole. Furthermore, the process of preparing and crisping, frying or baking a compartmentalized crepe is novel in that it further distinguishes the product from any other crepe, pancake or similar batter-based product.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiment.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

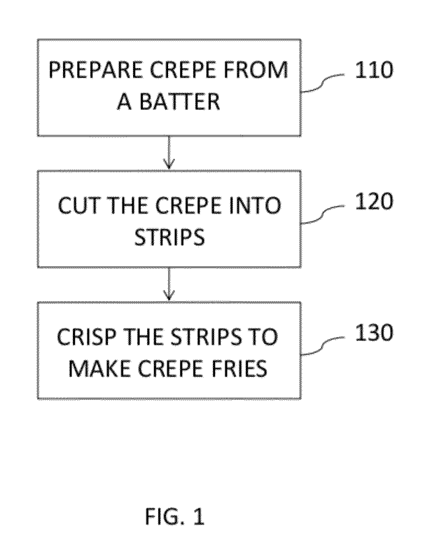

Turning now to the drawings, FIG. 1 is a flow chart of one exemplary method of preparing crepe fries according to this disclosure. According to one embodiment, a crepe is prepared from a batter (step 110), the crepe is then cut into strips (step 120) and the strips are crisped (step 130). It is to be appreciated that the crepe batter can be prepared according to many known recipes. It is to be appreciated the crepe can also be cut into strips according to various techniques known to those of skill in the art. It is further to be appreciated that the crisping of the crepe strips can be done, for example, by any of baking, frying, and deep frying the crepe strips, or by any other technique known to those of skill in the art. In one embodiment, the method may also include infusing the crepe batter with a flavoring. It is to be appreciated that any flavoring that is known to those of skill in the art can be used, and that the flavoring can be added after any of the steps noted above. In another embodiment, the method may include coating the crisped crepe fries with a flavoring. For example, the flavoring may be powdered sugar. It is to be appreciated that any flavoring that is known to those of skill in the art can be used and that the flavoring can be added after any of the steps noted above.

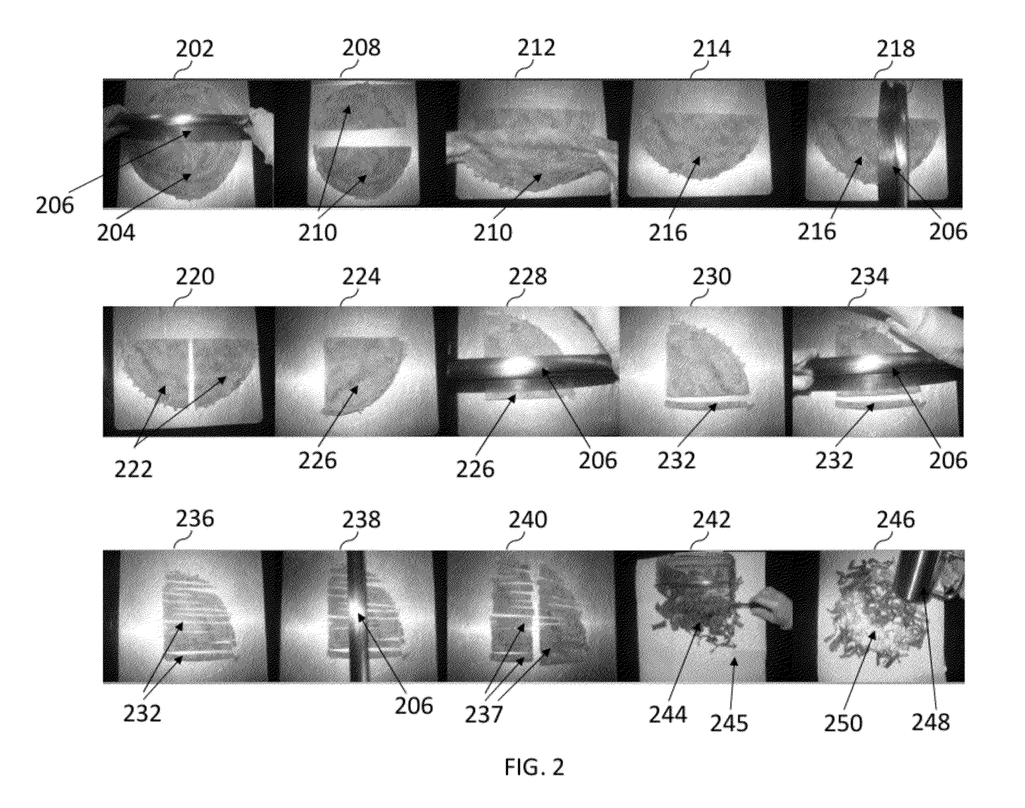

Referring to FIG. 2, there is illustrated one exemplary method of preparing crepe fries according to aspects disclosed herein. In particular, FIG. 2 includes example steps for cutting (step 120 of FIG. 1) and crisping (step 130 of FIG. 1) the strips of crepes as discussed above with reference to FIG. 1. In step 202 of FIG. 2, a whole, rounded crepe 204 is provided. It is to be appreciated that the crepe 204 need not initially be whole or round, and that any size and shape crepe can be used. Crepe 204 is cut using a pizza rocker 206 to initially provide two halves as shown in step 208. It is to be appreciated that other types of cutting devices, in addition to a pizza rocker, may also be used for cutting the crepe. According to one embodiment of the method disclosed herein, the whole crepe 204 is round and has a diameter of about 16 inches. However, the whole crepe 204 may be prepared in other shapes and sizes. According to one embodiment, the whole crepe 204 is cut along a center-line or a line of symmetry of the crepe. Thereby, as shown in step 208, the whole crepe 204 is divided into two halves 210 that have substantially identical shapes. Step 212 illustrates flipping one half 210 such that the two halves have the same orientation. Step 214 illustrates stacking the two halves by placing one half directly over the other half, resulting in a stacked crepe 216. Step 218 illustrates that the stacked crepe 216 is further cut along a center-line or a line of symmetry of the stacked crepe. Thereby, as shown in step 220, the stacked crepe 216 is divided into two halves 222 that are substantially identical. Each half 222 is a stack of two quarter pieces of the whole crepe 204. Step 224 includes flipping one half 222 such that the two halves 222 have the same orientation, and stacking the two halves by placing one half directly over the other half, resulting in a stacked crepe 226. The stacked crepe 226 includes four layers of the whole crepe 204. In step 228, the stacked crepe 226 is cut using the pizza rocker 206 to form a strip 232. The strip 232, shown in step 230, has a width of approximately 0.5 inches. In step 234, the stacked crepe 226 is further cut along substantially parallel lines to form strips having substantially uniform widths. In one example, the strips have nearly uniform widths of approximately 0.5 inches. It is to be appreciated that although one method of cutting and folding the crepe to provide crepe strips has been illustrated, that various other method of folding and cutting the crepe to provide the crepe strips having substantially uniform widths. It is also to be appreciated that the crepe strips may have different widths and that such widths may be patterned or random. As shown in step 236, the resulting strips may have varying lengths, but it is to be appreciated that the strips may also be provided with substantially uniform lengths. In step 238, the stacked crepe 226 that was cut into strips 232 is further cut along a line substantially perpendicular to the parallel lines along which the strips were cut. The resulting strips 237 have shorter lengths relative to the original strips 232, as shown in step 240. It is to be appreciated that this step 238 of cutting the strips of crepes along the line substantially perpendicular to the parallel strips is optional. It should also be appreciated that any of the above noted steps of the process are optional. According to one embodiment, the resultant crepe strips 237 (before crisping) are 3 to 4 inches long and 0.5 to 1 inches wide. In other embodiments, as noted above, the strips 237 may have uniform or variable lengths, which may for example depend on the shape of the initially prepared whole crepe 204.

In another embodiment of the method, cutting the whole crepe may include further repeating the steps of cutting the crepe along a line of symmetry (e.g. steps 202, 218), flipping one half and stacking the two halves to form a stacked crepe (e.g. steps 212, 224). The number of repetitions may depend on the shape and size of the whole crepe 204. The number of layers of the resulting stacked crepe may vary depending on the number of times the steps are performed.

Still referring to FIG. 2, step 242 illustrates the crepe fries 244 after the strips 237 have been deep fried to form the crepe fries 244. According to one embodiment, the crepe strips 237 are deep fried in canola oil at approximately 350 degrees Fahrenheit for approximately 45 seconds. It is to be appreciated that other frying oils, as known to those of skill in the art, may also be used. In other embodiments, the strips 237 may be fried (instead of deep fried) or baked until crispy. The strips may also be crisped by any other method known to those of skill in the art. Step 242 also illustrates that the crepe fries 244 are placed on an absorbent material such as a paper towel 245 to absorb any excess oil. It is to be appreciated that such step is optional. Step 246 illustrates adding powdered sugar to a sifter 246 and covering the crepe fries 244 liberally. It is to be appreciated that any amount of flavoring can be used and that the crepe fries 244 may be covered by other flavorings known to those of skill in the art. The resulting crepe fries can be served warm and may be preferred warm, but need not be. It is contemplated that according to one embodiment of the method of this disclosure that strips 237 cut from one 16 inch whole crepe 204 make a similar serving size of crepe fries 244 as a typical commercial large serving of French fries.

Some of the advantages of the method and resultant end food product of this disclosure are: the various embodiments of the method disclosed herein provides crepes that are both portable and versatile; such crepes can be served as a fast food option, and can be provided having different flavor options; such crepes “fries” have an increased appeal in a shopping or quick-treat environment; such method also provides for variability to create flavor options through any of different crepe batters, batter infusion, as well as by adding different flavorings.

Some additional advantages are that cutting the crepes into smaller compartments or strips allows for more effective basket or Fryolator cooking because the cooking oil is able to better reach all sides of the crepe strips quicker and with better distribution. In contrast, while crepes are not traditionally fried, frying crepes by placing multiple whole round crepes into a fryer may result in uneven cooking and pockets of uncooked portions of the crepe and/or filling. An increase in cooking time to cook these uncooked portions of such whole crepes may also result in overcooked portions. The methods of preparing crepe fries as disclosed herein provide a more evenly, lightly-crisped product that gives the flavor of a crepe (now crisped) in a bite-sized and portable version, which does not exist in crepe, pancake, or similar batter-based products.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the disclosure. Accordingly, the foregoing description and drawings are by way of example only, and the scope of the disclosure should be determined from proper construction of the appended claims, and their equivalents.

What is claimed is:

1. A method of preparing crepe fries, the method comprising:
preparing a crepe from a batter;
cutting the crepe into strips; and
crisping the strips to make crepe fries.

2. The method of claim 1, further comprising:
coating the crepe fries with a flavoring.

3. The method of claim 2, wherein the flavoring is powdered sugar.

4. The method of claim 1, further comprising preparing the batter.

5. The method of claim 4, wherein preparing the batter further includes adding a flavoring to the batter.

6. The method of claim 1, wherein preparing the crepe further includes rolling the batter into a crepe having a diameter of approximately 16 inches.

7. The method of claim 1, wherein cutting the crepe further includes using a pizza rocker to cut the crepe.

8. The method of claim 1, wherein cutting the crepe further includes cutting the crepe into strips having a length of approximately 3 to 4 inches and a width of approximately 0.5 to 1 inches.

9. The method of claim 1, wherein cutting the crepe further includes:
dividing the crepe into two halves by cutting along a line of symmetry of the crepe, the two halves being substantially identical;
flipping one half such that the two halves have the same orientation; and
stacking the two halves having the same orientation to make a stacked crepe.

10. The method of claim 9, further including:
dividing the stacked crepe into two halves by cutting along a line of symmetry of the stacked crepe, the two halves being substantially identical;
flipping one half such that the two halves have the same orientation; and
stacking the two halves having the same orientation.

11. The method of claim 10, further including:
cutting the stacked crepe along substantially parallel lines to form strips having a substantially uniform width of approximately 0.5 inches.

12. The method of claim 11, wherein cutting the stacked crepe further includes:
cutting the stacked crepe along a direction substantially perpendicular to the parallel lines.

13. The method of claim 1, wherein crisping the strips further includes:
deep frying the strips at a temperature of approximately 350 degrees Fahrenheit.

14. The method of claim 13, wherein crisping the strips further includes:
deep frying the strips for approximately 45 seconds.

15. The method of claim 1, wherein crisping the strips further includes:
deep frying the strips until the crepe fries are crispy.

16. The method of claim 1, wherein crisping the strips further includes baking the strips.

17. The method of claim 1, wherein crisping the strips further includes:
placing the hot crepe fries on an absorbent material.

18. Crepe fries having been prepared by the method of claim 1.
